(19) United States
(12) Patent Application Publication
(10) Pub. No.: US 2008/0268405 A1
(43) Pub. Date: Oct. 30, 2008

(54) Hygiene training device and method

(76) Inventors: Jason C. Cohen, Appleton, WI (US); Thomas Gerard Shannon, Neenah, WI (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/796,354

(22) Filed: Apr. 27, 2007

(51) Int. Cl. G09B 11/00

(52) U.S. Cl. 434/81

(57) ABSTRACT

A training device includes a first marking mechanism adapted to deliver a first colorant to a skin surface, wherein the first colorant is adapted to be washed from the skin surface with a cleaner. The training device may also include a second marking mechanism adapted to deliver a second colorant to the skin surface or a faux marking surface adapted to deliver no ink to the skin surface. The training device may be used as part of a method and/or kit for hand hygiene.

### BACKGROUND OF THE INVENTION

The benefits of proper hand washing are well documented. This is particularly apt after using the restroom. However, despite the known benefits, not all people regularly and properly wash their hands. This is particularly true with children who may not appreciate the benefits of hand washing and may not be attended to at wash times. As such, children may not wash their hands at all and/or may not wash their hands for an adequate amount of time and/or may not wash with an adequate cleaner. Parental supervision and coaching can improve children's hand washing habits, but parents or caregivers are not always able to be with the child in the bathroom.

Several products have been introduced to encourage children to wash their hands for a proper length of time using a suitable cleaner. While these systems may improve hand washing habits, they may also be easily by-passed by children and are not always available when away from home. For example, some products include a pad that applies a mark to the hand when soap is dispensed. The recipient of the soap and the mark are instructed to wash their hands until the mark is removed. However, children can easily avoid the marking pad when dispensing the soap or children may wash without using soap or children may simply skip washing all together.

Other products include various timing devices, such as flashing lights, which encourage children to wash their hands for the duration of the flashing light. Again, children can skip washing or can ignore the flashing light thereby by-passing the system.

Therefore, there remains a need for a system of training children in proper hand washing hygiene that is fun for children to use, difficult to by-pass, portable, and rewards good hand washing.

### SUMMARY OF THE INVENTION

In response to this need, the present invention provides devices, methods, and kits that assist in teaching children proper hand washing hygiene. The devices, methods, and kits of the present invention provide positive feedback for children, are difficult to by-pass due to caregiver interaction, and are easily portable. The devices, methods, and kits of the present invention provide a fun, visual learning method for the child while assuring the caregiver that the child has properly washed their hands. Furthermore, the devices, methods, and kits of the present invention provide a means for developing, in the child, independent hand hygiene habits while providing the caregiver with the same assurance as would be received by direct supervision of the child during hand washing.

In one aspect, the present invention provides a training device having a first marking mechanism adapted to deliver a first colorant to a skin surface. The first colorant is adapted to be washed from the skin surface with a cleaner. The training device also includes a second marking mechanism adapted to deliver a second colorant to the skin surface. The second colorant is adapted to disappear within a predetermined amount of time after delivery to the skin surface. In various embodiments, the first colorant may be adapted to be washed from the skin in 20 to 45 seconds of washing with a cleaner. In some embodiments, the first colorant may be a polyalkyleneoxy-substituted chromophore compound and the second colorant may be a water-based pH indicator. In some embodiments, the first colorant may be soluble in alcohol.

In some embodiments, the first marking mechanism of the training device may include a first stamping surface adapted to deliver the first colorant to the skin as a first mark having a first pattern. Likewise, the second marking mechanism of the training device may include a second stamping surface adapted to deliver the second colorant to the skin as a second mark having a second pattern. In some embodiments, the first pattern may include a first image suggesting the presence of germs and the second pattern may include a second image suggesting the elimination of germs. In some embodiments, the first pattern and the second pattern may be the same. In some embodiments, the first pattern and the second pattern may be different. In some embodiments, the first pattern may have a first theme and the second pattern may have a second theme wherein the first theme and the second theme are the same.

In some embodiments, the training device may be part of a training kit. The training kit may include a training device and instructions describing a method of training a child to wash their hands. The method may include the steps of: marking a hand of the child with the first ink to create a first mark; instructing the child to wash the hand with a cleaner to remove the first mark; inspecting the hand of the child to confirm the absence of the first mark; marking the hand of the child with the second ink to create a second mark. In some embodiments, the training kit may include the training device and a cleaner. In some embodiments, the training device has a theme and the cleaner has the same theme. In some embodiments, the kit has a first colorant that is soluble in alcohol and a cleaner that includes alcohol.

In another aspect, the present invention provides a training device having a marking surface adapted to deliver a first ink to a skin surface to define a mark. The first ink may be adapted to be washed from the skin surface with soap and water. The training device may further have a faux marking surface adapted to look and feel like the marking surface, wherein the faux marking surface is adapted to deliver no ink to the skin surface.

In some embodiments, the first ink is a polyalkyleneoxy-substituted chromophore compound. In some embodiments, the training device may be part of a training kit. The training kit may also include instructions describing a method of training a child to wash their hands. The method includes the steps of stamping a hand of a child with the marking surface to deliver the first ink to the hand and to create the first mark having the first pattern. The method further includes the step of instructing the child to wash the hand with soap and water for a predetermined amount of time to remove the mark. The method further includes the step of inspecting the hand of the child to confirm the removal of the first mark. The method further includes the step of stamping the hand of the child with the faux marking surface to deliver no ink to the hand.

In some embodiments the method may further include suggesting to the child that the absence of a second mark indicates that germs have been reduced or eliminated.

In another aspect, the present invention provides a method of providing a system for training a child to wash their hands. The method includes providing a training device wherein the training device includes a first stamping surface adapted to deliver a first ink to a hand to create a first mark having a first pattern, wherein the first ink is water soluble and is adapted to be washed from the hand with soap,and water. The method further includes a second stamping surface adapted to deliver a second ink to the hand to create a second mark having a second pattern, wherein the second ink is adapted to disappear within a predetermined amount of time. The method further includes instructing a caregiver to press the first stamping surface against the hand of the child to deliver the first ink to the hand and create the first mark. The method further includes instructing the caregiver to instruct the child to wash the hand until the first mark is removed. The method further includes instructing the caregiver to inspect the hand of the child to confirm the removal of the first mark. The method further includes instructing the caregiver to press the second stamping surface against the hand of the child to transfer the second ink to the hand and to create the second mark. The method further includes instructing the caregiver to allow the second mark to disappear. The method thereby enables the caregiver to train a child to wash their hands.

In some embodiments, the method further includes instructing the caregiver to communicate to the child that the first mark indicates the presence of germs. In some embodiments, the method further includes instructing the caregiver to communicate to the child that the disappearance of the second mark indicates the absence of germs.

### BRIEF DESCRIPTION OF THE DRAWINGS

FIG. 1 representatively illustrates an exemplary training device of the present invention.

FIG. 2 representatively illustrates an exemplary marking surface of a training device of the present invention.

FIG. 3 representatively illustrates an exemplary marking surface of a training device of the present invention.

FIG. 4 representatively illustrates an exemplary mark on a hand.

FIG. 5 representatively illustrates an exemplary mark on a hand.

FIG. 6 representatively illustrates an exemplary training device of the present invention.

FIG. 7 representatively illustrates an exemplary marking surface of a training device of the present invention.

FIG. 8 representatively illustrates an exemplary faux marking surface of a training device of the present invention.

FIG. 9 representatively illustrates an exemplary training kit of the present invention.

### DETAILED DESCRIPTION OF THE INVENTION

As discussed above, training children in proper hand washing hygiene is desirable for many caregivers. In various aspects, the present invention provides devices, kits, and methods suitable for teaching proper hand washing hygiene.

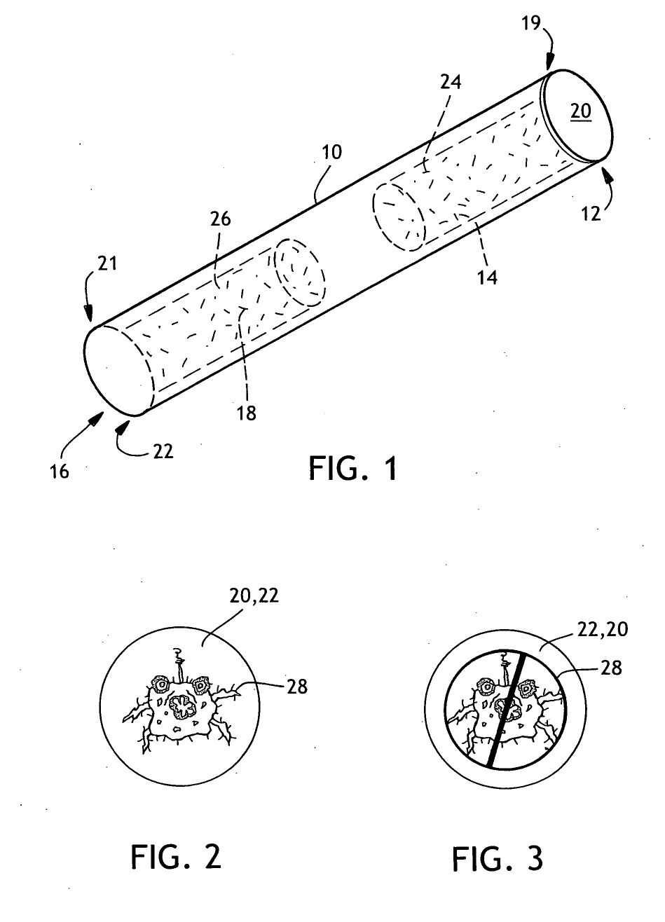

In one aspect, the present invention provides a training device suitable for assisting caregivers in teaching children proper hand washing hygiene. For example, as illustrated in FIG. 1, a training device 10 may include a first marking mechanism 12 adapted to deliver a washable colorant 14 to a skin surface to define a first mark and a second marking mechanism 16 adapted to deliver a fading colorant 18 to the skin surface to define a second mark. The washable colorant 14 may be adapted to be removed from the skin surface by any suitable means, such as by washing with soap, water, or other cleansing means, or combinations thereof. The fading colorant 18 may be adapted to lighten and/or disappear within a predetermined amount of time after delivery to the skin surface.

Any suitable marking mechanism may be used to deliver the washable colorant 14 and/or the fading colorant 18 to the skin surface. For example, the marking mechanism may be a stamp, spray mechanism, wiper, pen, roller ball applicator, or the like, or combinations thereof. For example, as illustrated in FIG. 1, the first marking mechanism 12 and the second marking mechanism 16 are configured as a first stamp 19 and a second stamp 21. Stamps are well known in the art and may include separate ink pads. However, in some embodiments, the stamps may be self-inking with the marking surface in fluid communication with one or more reservoirs containing one or more washable colorants and/or fading colorants.

For example, as illustrated in FIG. 1, the training device 10 includes a first marking mechanism 12 configured as a first stamp 19 and a second marking mechanism 16 configured as a second stamp 21. The first marking mechanism 12 includes a first marking surface 20 in fluid communication with a first reservoir 24 which contains washable colorant 14. Likewise, the second marking mechanism 14 includes a second marking surface 22 in fluid communication with a second reservoir 26 which contains fading colorant 18. The first marking surfaces 20 and/or 22 may be made from any suitable material or materials capable of transferring the colorants 14 and/or 18 from the reservoirs 24 and/or 26 to a target surface such as the skin of the hand.

The marking surfaces 20 and 22 may be directly or indirectly in fluid communication with the reservoirs 24 and 26. For example, a wicking component may be situated therebetween. The reservoirs 24 and 26 may be any suitable shape and/or size. In some embodiments, the reservoirs 24 and 26 may be refillable with colorants 14 and/or 18. In some embodiments, the reservoirs 24 and 26 may be adapted to receive one or more cartridges containing colorants 14 and/or 18.

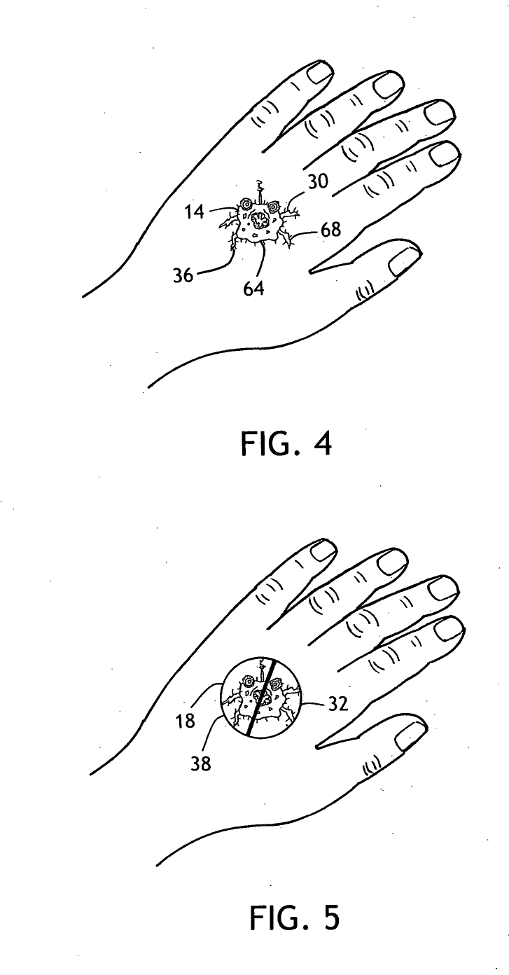

In some embodiments, the marking surfaces 20 and/or 22 may include one or more raised images formed thereon to transfer a pattern of colorants 14 and/or 18 corresponding to the one or more raised images thereby defining first and/or second marks. In some embodiments, the pattern may be transferred to a person's hand by pressing the marking surface 20 and/or 22 against a person's hand. For example, FIG. 2 representatively illustrates a marking surface 20 and/or 22 having a raised image 28 of a fictionalized germ. As described above, the marking surface 20 and/or 22 may be in fluid communication with colorants 14 or 18 such that pressing the marking surface 20 and/or 22 against a person's hand transfers colorant 14 or 18 as a fictionalized germ pattern 30 to define a mark as illustrated in FIG. 4. In FIG. 4, the mark is illustrated on the back of the hand, but it will be readily appreciated by those skilled in the art that any of the marks disclosed herein may be placed on any suitable surface or surfaces. For example, a mark may be transferred to the palm of the hand.

FIG. 3 representatively illustrates a marking surface 20 and/or 22 having a raised image 28 of a fictionalized germ that has been “canceled.” The marking surface 20 and/or 22 may be in fluid communication with colorants 14 or 18 such that pressing the marking surface 20 and/or 22 against a person's hand transfers colorant 14 or 18 as a canceled fictionalized germ pattern 32 to define a mark as illustrated in FIG. 5. In some embodiments, the marking surfaces 20 and/or 22 may include one or more recessed images formed therein to transfer a pattern of colorants 14 and/or 18 corresponding to the negative of the recessed images thereby defining first and/or second marks.

In various embodiments, the washable colorant 14 and/or the fading colorant 18 may be delivered as any suitable pattern, image, message, symbol, text, picture, or the like, and combinations thereof. In some embodiments, the washable colorant 14 may be delivered in a first pattern and the fading colorant 18 may be delivered in a second pattern. In some embodiments, the first pattern and the second pattern may be the same or different. In some embodiments, the patterns may include one or more images that suggest the presence of germs. For example, FIG. 4 illustrates a pattern 30 that suggests the presence of germs. In some embodiments, the patterns may include one or more images that suggest the absence, reduction, or elimination of germs. For example, FIG. 5 illustrates a pattern 32 that suggests the elimination of germs.

In various embodiments, the first pattern may have a first theme and the second pattern may have a second theme wherein the first theme and,the second theme are the same or different. Any suitable themes may be used. For example, suitable themes may include “fighting germs,” “scaring away monsters,” “removing dirt,” “good versus evil,” and the like, and combinations thereof. In some embodiments, cleaners and other associated accessories (e.g., sponges and towels) may also be provided with one or more images related to the same theme.

The training device 10 may be used as part of a method to ensure a child properly washes their hands and to reward the child for their success. For example, one suitable method includes a caregiver delivering the washable colorant 14 to the hand or hands of a child to create a first mark 36 as representatively illustrated in FIG. 4. In some embodiments, the method may further include the caregiver suggesting to the child that the first mark 36 created with washable colorant 14 indicates and/or illustrates that germs are present on the hands. The caregiver may then instruct the child to wash their hands using an appropriate cleaner, such as soap and water, to remove the first mark 36 from the skin. The caregiver may then inspect the hand or hands of the child to confirm the absence of the first mark 36. The caregiver may then deliver the fading colorant 18 to the hand or hands of the child to create a second mark 38 as representatively illustrated in FIG. 5. When the fading colorant 18 fades and/or disappears, the caregiver may suggest to the child that the fading and/or disappearance of the second mark 38 created by the fading colorant 18 indicates and/or illustrates that the germs are absent, reduced, or eliminated from the hands. In this manner, the child properly washes their hands and they are rewarded by a visual representation of their success. The method of using the training device 10 may be communicated by any suitable means. For example, the method may be communicated via instructions included with the training device 10, a kit, or any other suitable means, or combinations thereof.

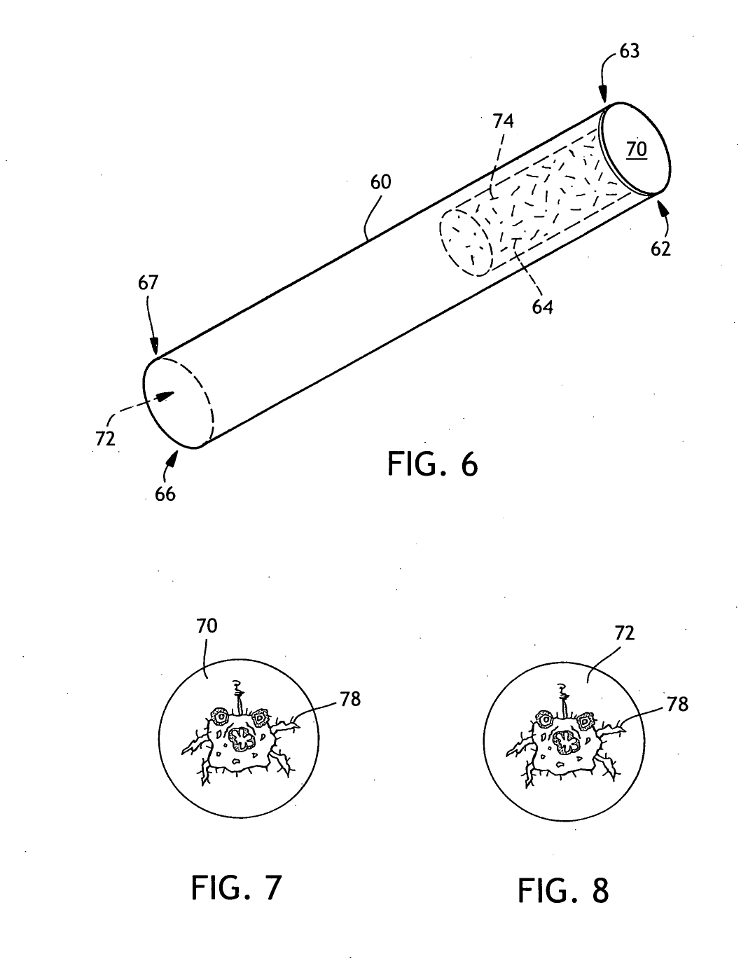

In another aspect, the present invention provides a training device suitable for assisting caregivers in teaching children proper hand washing hygiene. For example, as illustrated in FIG. 6, a training device 60 may include a marking mechanism 62 adapted to deliver a washable colorant 64 to a skin surface. The training device 60 may also include a faux marking mechanism 66 adapted to deliver no colorant to the skin surface. The washable colorant 64 may be adapted to be removed from the skin surface by any suitable means, such as by washing with soap, water, or other cleansing means, or combinations thereof.

Any suitable marking mechanism may be used to deliver the washable colorant 64 to the skin surface. For example, the marking mechanism may be a stamp, spray mechanism, wiper, pen, roller ball applicator, or the like, or combinations thereof. For example, as illustrated in FIG. 6, the marking mechanism 62 and faux marking mechanism 66 are configured as a first stamp 63 and a faux stamp 67. Stamps are well known in the art and may include separate ink pads. However, in some embodiments, the stamps may be self-inking with the marking surface in fluid communication with the reservoir for the washable colorant.

For example, as illustrated in FIG. 6, the training device 60 includes a marking mechanism 62 configured as a first stamp 63 and a faux marking mechanism 66 configured as a faux stamp 67. The marking mechanism 62 includes a marking surface 70 in fluid communication with a reservoir 74 which contains washable colorant 64. The faux marking mechanism 64 includes a faux marking surface 72. The marking surface 70 may be made from any suitable material capable of transferring the colorants 64 from the reservoir 74 to a target surface such as the skin of the hand. The faux marking surface 72 may be made of similar materials to the marking surface 70 to produce a similar appearance and feel as compared to the marking surface 70. In some embodiments, not illustrated, the faux marking surface 72 may be in fluid communication with a reservoir having a colorless fluid, such as water or alcohol, to simulate the “wet” feel of the marking surface 70. In some embodiments, the faux marking surface 72 may be the same color as the marking surface 70 when the marking surface 70 is in fluid communication with reservoir 74 containing the washable colorant 64. This gives the impression to the child that the marking mechanism 62 and the faux marking mechanism 66 are identical.

The marking surface 70 may be directly or indirectly in fluid communication with the reservoir 74. For example, a wicking component may be situated therebetween. The reservoir 74 may be any suitable shape and/or size. In some embodiments, the reservoir 74 may be refillable with colorant 64. In some embodiments, the reservoir 74 may be adapted to receive one or more cartridges containing colorant 74.

In some embodiments, the marking surface 70 may include a raised image formed thereon to transfer a pattern of colorants 64 corresponding to the raised image. In some embodiments, the pattern may be transferred to a person's hand by pressing the marking surface 70 against a person's hand. In some embodiments, the faux marking surface 72 may include a raised image formed thereon to look and feel like the raised image on marking surface 70. In these embodiments, no pattern may be transferred to a person's hand by pressing the faux marking surface 72 against a person's hand. For example, FIG. 7 representatively illustrates a marking surface 70 having a raised image 78 of a fictionalized germ. As described above, the marking surface 70 may be in fluid communication with colorant 64 such that pressing the marking surface 70 against a person's hand would transfer colorant 64 as a fictionalized germ pattern 30 to deliver a mark 68 as illustrated in FIG. 4. In contrast, FIG. 8 representatively illustrates a faux marking surface 72 having the same raised image 78 of the fictionalized germ. The faux marking surface 72 is not in fluid communication with any colorant and therefore pressing the faux marking surface 72 against a person's hand does not transfer any colorant and does not define any mark.

In some embodiments, the marking surface 70 and the faux marking surface 72 may include one or more recessed images formed therein. The marking surface 70 would therefore be adapted to transfer a pattern of colorant 64 corresponding to the negative of the recessed image thereby define a first mark.

The training device 60 may be used as part of a method to ensure a child properly washes their hands and to reward the child for their success. For example, one suitable method includes a caregiver delivering the washable colorant 64 to the hand or hands of a child to create a first mark 68 as representatively illustrated in FIG. 4. In some embodiments, the method may further include the caregiver suggesting to the child that the first mark 68 created with washable colorant 64 indicates and/or illustrates that germs are present on the hands. The caregiver may then instruct the child to wash their hands using an appropriate cleaner, such as soap and water, to remove the mark 68 from the skin. In some embodiments, the caregiver may then inspect the hand or hands of the child to confirm the absence of the mark 68. The caregiver may then pretend to deliver a colorant to the hand or hands of the child using the faux marking mechanism 66. When no colorant is visible, the caregiver may suggest to the child that the absence of a mark indicates and/or illustrates that the germs are absent, reduced, or eliminated from the hands. In this manner, the child properly washes their hands and they are rewarded by a visual representation of their success. The method of using the training device 60 may be communicated by any suitable means. For example, the method may be communicated via instructions included with the training device 60, a kit, or any other suitable means, or combinations thereof.

In some embodiments, any suitable additional features may be included with the training devices. For example, the devices may include one or more caps as are well known in the art to protect and/or preserve the marking mechanisms and/or the colorants. In another example, the training devices may include one or more light producing devices. The light producing devices may be adapted to produce a light when a marking mechanism or a faux marking mechanism is triggered. The marking mechanism or faux marking mechanism may be triggered by pushing a button, squeezing a trigger, wiping against a surface, pressing against a surface, or the like, or combinations thereof.

In another example, the training devices may further include one or more sound producing devices. In some embodiments, the sound producing devices may be adapted to produce a sound when a marking mechanism or a faux marking mechanism is triggered. In some embodiments, a first sound may be activated when the washable ink is transferred to the skin. For example, the first sound may say “Yuck, GERMS!”, In some embodiments, a second sound may be activated when the fading ink is transferred to the skin and/or when the faux marking mechanism is activated. For example, the second sound may say, “Yea, No GERMS!”

The washable colorants may be any suitable composition or compositions that are removable with a cleaner. For example, the washable colorants may include paints, dyes, chalks, stains, inks, greases, pigments, and the like, and combinations thereof which clearly mark the child's hand. Suitable colorants are disclosed in U.S. Pat. No. 4,169,169 issued to Kitabataka which is incorporated herein by reference where not contradictory.

In some embodiments, the washable colorants may be a dye or ink and may include aqueous ink/dye compositions that are washable with soap and water. For example, U.S. Pat. No. 5,043,013 issued to Kluger et al., which is incorporated herein by reference where not contradictory, teaches washable colorant compositions containing polyalkyleneoxy-substituted, polar group-substituted chromophore compounds. These colorants may have a high molecular weight colorant which is believed to be less toxic to humans and may make other solvents unnecessary. Kluger teaches that an aqueous ink composition may contain from about 40 percent by weight to about 80 percent by weight of water; from about 10 percent by weight to about 50 percent by weight of polymeric colorant containing a polar chromophore with from about 10 percent by weight to about 50 percent by weight of polyalkylene oxide units. The polymeric colorants selected for the washable colorant compositions may contain from about 5 percent by weight to 40 percent by weight of a polyalkylene oxide (e.g., ethylene oxide). In addition, it may be desirable to add well known additives such as humectants to prevent or minimize drying of the ink composition. Additionally, a biocide or bactericide (e.g., methyl and propyl parasepts) may be added to improve shelf-life of the ink composition. Additionally, a chelating agent (e.g., EDTA) may be provided to the ink composition to improve shelf-life. The ink may also include other additives such as binders (e.g., cellulose derivatives), plasticizers (e.g., citric acid ester), and solvents (e.g., aromatic hydrocarbons).

In some embodiments, the washable colorants may be soluble in water, surfactants, alcohols, or other polar solvents, and combinations thereof. Suitable solvents may include n-propanol, iso-propanol, and the like, and combinations thereof. Therefore suitable cleaners may include water, soap, alcohol, and the like, and combinations thereof.

While water is the preferred solvent for the washable colorant, some embodiments may additionally or alternatively include other solvents or co-solvents as suitable. With some water soluble inks, if the hands are washed too soon after marking the hand the ink will disappear with just water or disappear immediately upon washing. Therefore, an alcohol solvent may be preferred in some embodiments to assist in drying after application of the marker.

In some embodiments, washing with alcohol instead of water may be desirable and accordingly a water insoluble ink or dye may be preferred. As disclosed in U.S. Pat. No. 6,211,788 to Lynn et al., examples of nontoxic oil dyes permitted to be used in medicine and cosmetics include red dyes such as 3-esoacetate of 9-o-carboxyphenyl-6-diethylamino-3-ethylimino-3-iso-xanthene (Red No. 215, Rhodamine B Stearate), 2,4,5,7-tetrabromo-12,13,14,15-tetrachloro-3,6,-fluorandiol (Red No. 218, Tetrachlorotetrabromofluorescein), 2,4,5,7-tettrabromo-3,6-fluorandiol (Red No. 223, Tetrabromofluorescein), 1-p-phenylazo-phenylazo-2-naphthol (Red No. 225, Sudan III), o-tolylazo-o-tolylazo-2-naphthol (Red No. 501, Medical Scarlet), 1-xylylazo-2-naphthol (Red No. 505, Oil Red XO), orange dyes such as 4,5-dibromo-3,6-flourandiol (Orange No. 201, Dibromofluorescein), 1-o-tolylazo-2-naphthol (Orange No. 403, Orange SS), 4,5-diiodo-3,6-fluorandiol (Orange No. 206, Diiodofluorescein), yellow dyes such as 3,6-fluorandiol (Yellow No. 201, Fluorescein), 2-(2-quinolyl)-1,3-indandione (Yellow No. 204, Quinoline Yellow SS), 1-phenylazo-2-naphthylamine (Yellow No. 404, Yellow AB), 1-o-tolylazo-2-naphthylamine (Yellow No. 405, Yellow OB), green dyes such as 1,4-bis(p-toluino)anthraquinone (Green No. 202, Quinizarin Green SS), blue dyes such as 1-methyamino-4-o-tolylaminoanthraquinone (Blue No. 403, Sudan Blue B), and violet dyes such as 1-hydroxy-4-p-toluinoanthraquinone (Violet No. 201, Arizroll Purple SS).

In some embodiments, the washable colorants may be adapted to be removed with a cleaner after a predetermined amount of time. For example, the washable colorants may be adapted to be removed in 15 to 20 seconds of washing with a suitable cleaner. For example, U.S. Patent Application 2005/0231373 to Lynn et al., discloses that commercially available substances such as tourquoise 1-7054 ink 203-52 from Ranger Ink and “Care Bears Lite Up Stampers” from Rose Art, Inc. come off the hands in 15-20 seconds with soap and warm water. In some embodiments, the washable colorants may be removed with soap and water in 10-120 seconds or 20-60 seconds. By adapting the washable colorants to be removed within a predetermined amount of time, proper hand hygiene may be achieved without excessive washing required.

In a specific example, a 1″ line was applied to the palm of the hand with a SHARPIE brand fine point marker #30004 (Green) and allowed to sit for 5-seconds prior to washing. The hand was then washed for 45 seconds with warm water and K-C ANTIBACTERIAL SKIN CLEANSER brand soap manufactured and distributed by Kimberly-Clark Professional, Roswell, Ga., U.S.A. No marker was detected after 45 seconds of washing. It was found that the color did not fade appreciably until more than 20 seconds of washing but was completely gone by 40 seconds. Using the same protocol without soap showed the mark to be very intense even after 30 seconds of washing.

The fading colorants may be any suitable composition that fades or disappears within a predetermined amount of time. In some embodiments, the fading colorants may be a dye or ink. In some embodiments, the fading colorants may be adapted to fade or disappear after 1, 3, 5, 10, 20, 30, or 40 seconds of being exposed to air, light, heat, or combinations thereof. In some embodiments, the fading colorants may be adapted to disappear or fade within 5, 10, 20, 30, 40, 50, or 60 seconds of being exposed to air, light, heat, or combinations thereof.

In some embodiments, suitable fading colorants may be a water-based acid-based indicator (pH indicator) that changes from a colored to a colorless solution upon exposure to air. Suitable pH indicators for the fading colorants may include, but are not limited to, indicators such as thymol blue, tropeolin OO, methyl yellow, methyl orange, bromphenol blue, bromcresol green, methyl red, bromthymol blue, phenol red, neutral red, phenolphthalein, thymolphthalein, alizarin yellow, tropeolin O, nitramine, and trinitrobenzoic acid. The indicators may be mixed into a basic solution that becomes more acidic upon exposure to air, causing the color change. The disappearing colorant is believed to result from the water in the ink reacting with carbon dioxide in the air to form carbonic acid. The carbonic acid is then believed to react with sodium hydroxide in a neutralization reaction to form sodium carbonate. Neutralization of the base causes a color change of the indicator and the color disappears.

A suitable fading colorant may be prepared as follows: 0.10 grams of thymolphthalein (or phenolphthalein) is dissolved in 10 milliliters (ml) of ethyl alcohol and 90 ml of water is added to the solution while stirring. A 0.5M solution of sodium hydroxide is added dropwise until the solution turns a dark blue or red depending on the particular indicator used. The amount of time it takes for the color to disappear can be controlled by adjusting the pH or the amount of dye present. The pH of the solution may be controlled so as not to exceed a pH of 11.

As disclosed in U.S. Pat. No. 4,171,982 to Lin, copper sulphate and red acetate may be colored temporarily. Copper sulphate on exposure to ammonia fumes yields a dark blue compound, but exposure of the ammonia to air causes the ink to become invisible due to the high volatility of ammonia. As disclosed in U.S. Pat. No. 5,586,501 to Burguera et al., a disappearing ink may be a mixture of 10% ethanol, 1% o-Cresol Phthalein and 50 mM of aqueous NaCO3. Additionally, the o-Cresol Phthalein may be substituted by other pH indicators. Likewise, the NaCO3 may be substituted by a wide variety of basic compounds.

The various colorants may be provided in any suitable manner. For example, the colorants may be a fluid, gel, solid, semi-solid, and the like, and combinations thereof. The colorants may also be provided in or on a substrate such as a wiper, sponge, foam, felt, or the like or combinations thereof.

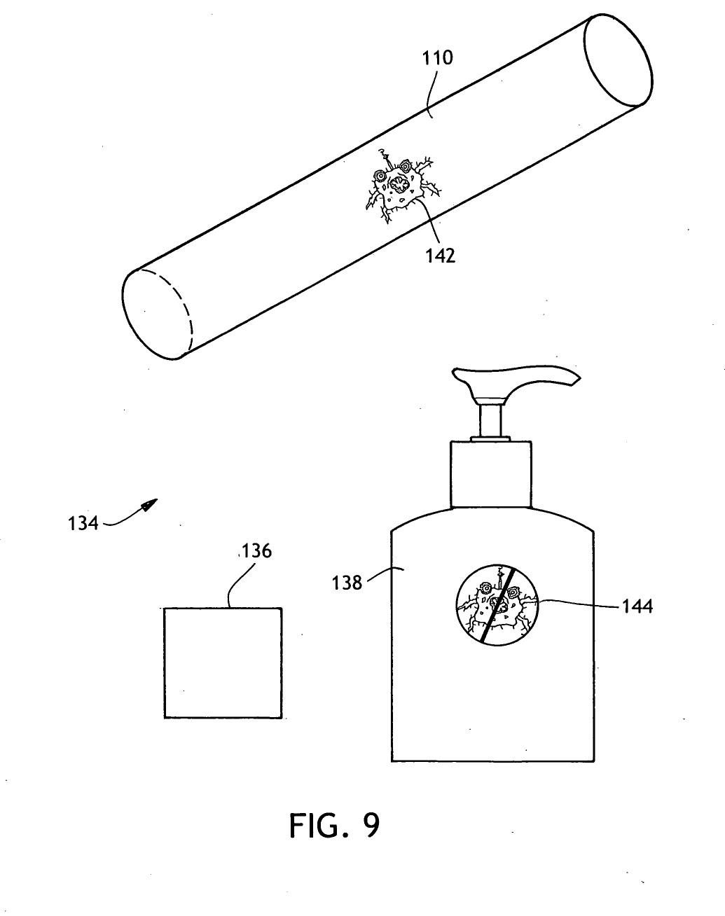

In some embodiments, various training devices may be provided as part of a training kit. An exemplary training kit may include any suitable training device and instructions describing a method of training a child to wash their hands and/or a cleaner. For example, an exemplary training kit 134 is illustrated in FIG. 9. The training kit 134 may include training device 110 and/or instructions 136 and/or cleaner 138. In various embodiments, training kits may additionally or alternatively be provided with any other suitable accessory such as, for example, towels, wipes, and the like and combinations thereof.

In some embodiments, training kits may include a common theme wherein the training device and/or the cleaner and/or the instructions and/or other accessories each have the same theme. For example, the training kit 134 illustrated in FIG. 9 has the theme of “fighting germs.” Additionally, the training device 110 has an image 142 of a germ which is associated with the theme “fighting germs.” Likewise, the cleaner 138 has an image 144 of a canceled germ which is also associated with the theme “fighting germs.” In some embodiments, the instructions may also include text, images, pictures, and the like, and combinations thereof that are also associated with the theme.

In some embodiments, training kits may be provided with a training device and a cleaner wherein the training device includes a washable colorant and wherein the washable colorant is soluble in a particular substance and the cleaner contains the particular substance. For example, a training kit may be provided with a training device that includes a washable colorant that is soluble in alcohol and the training kit may provide a cleaner that includes alcohol.

While the invention has been described in detail with respect to specific embodiments thereof, it will be appreciated that those skilled in the art, upon attaining understanding of the foregoing will readily appreciate alterations to, variations of, and equivalents to these embodiments. Accordingly, the scope of the present invention should be assessed as that of the appended claims and any equivalents thereto. Additionally, all combinations and/or sub-combinations of the disclosed embodiments, ranges, examples, and alternatives are also contemplated.

1. A training device comprising
a first marking mechanism adapted to deliver a first colorant to a skin surface, wherein the first colorant is adapted to be washed from the skin surface with a cleaner; and
a second marking mechanism adapted to deliver a second colorant to the skin surface, wherein the second colorant is adapted to disappear within a predetermined amount of time after delivery to the skin surface.

2. The training device of claim 1 wherein the first colorant is adapted to be washed from the skin in 20 to 45 seconds of washing with the cleaner.

3. The training device of claim 1 wherein the first colorant is a polyalkyleneoxy-substituted chromophore compound and the second colorant is a water-based pH indicator.

4. The training device of claim 1 wherein the first colorant is soluble in alcohol.

5. The training device of claim 1 wherein the first marking mechanism comprises a first stamping surface adapted to deliver the first colorant to the skin as a first mark having a first pattern and the second marking mechanism comprises a second stamping surface adapted to deliver the second colorant to the skin as a second mark having a second pattern.

6. The training device of claim 5 wherein the first pattern includes a first image suggesting the presence of germs and the second pattern includes a second image suggesting the elimination of germs.

7. The training device of claim 5 wherein the first pattern and the second pattern are the same.

8. The training device of claim 5 wherein the first pattern and the second pattern are different.

9. The training device of claim 8 wherein the first pattern has a first theme and the second pattern has a second theme and wherein the first theme and the second theme are the same.

10. A training kit comprising, the training device of claim 1 and instructions describing a method of training a child to wash their hands, wherein the method comprises,
marking a hand of the child with the first ink to create a first mark,
instructing the child to wash the hand with a cleaner to remove the first mark,
inspecting the hand of the child to confirm the absence of the first mark,
marking the hand of the child with the second ink to create a second mark.

11. A training kit comprising, the training device of claim 1 and a cleaner.

12. The training kit of claim 11 wherein the training device has a theme and the cleaner has the same theme.

13. The training kit of claim 11 wherein the first colorant is soluble in alcohol and the cleaner includes alcohol.

14. A training device comprising
a marking surface adapted to deliver a first ink to a skin surface to define a mark, wherein the first ink is adapted to be washed from the skin surface with soap and water, and
a faux marking surface adapted to look and feel like the marking surface, wherein the faux marking surface is adapted to deliver no ink to the skin surface.

15. The training device of claim 14 wherein the first ink is a polyalkyleneoxy-substituted chromophore compound.

16. A training kit comprising the training device of claim 14 and instructions describing a method of training a child to wash their hands, wherein the method comprises,
stamping a hand of a child with the marking surface to deliver the first ink to the hand and to create the first mark having the first pattern,
instructing the child to wash the hand with soap and water for a predetermined amount of time to remove the mark,
inspecting the hand of the child to confirm the removal of the first mark,
stamping the hand of the child with the faux marking surface to deliver no ink to the hand.

17. The training kit of claim 16 wherein the method further includes suggesting to the child that the absence of a second mark indicates that germs have been reduced or eliminated.

18. A method of providing a system for training a child to wash their hands, comprising,
providing a training device comprising,
a first stamping surface adapted to deliver a first ink to a hand to create a first mark having a first pattern, wherein the first ink is water soluble and is adapted to be washed from the hand with soap and water; and
a second stamping surface adapted to deliver a second ink to the hand to create a second mark having a second pattern, wherein the second ink is adapted to disappear within a predetermined amount of time,
instructing a caregiver to press the first stamping surface against the hand of the child to deliver the first ink to the hand and create the first mark,
instructing the caregiver to instruct the child to wash the hand until the first mark is removed,
instructing the caregiver to inspect the hand of the child to confirm the removal of the first mark,
instructing the caregiver to press the second stamping surface against the hand of the child to transfer the second ink to the hand and to create the second mark,
instructing the caregiver to allow the, second mark to disappear,
thereby enabling the caregiver to train a child to wash their hands.

19. The method of claim 18 further comprising instructing the caregiver to communicate to the child that the first mark suggests the presence of germs.

20. The method of claim 19 further comprising instructing the caregiver to communicate to the child that the disappearance of the second mark suggests the absence of germs.
